(19) United States
(12) Patent Application Publication
(10) Pub. No.: US 2005/0046327 A1
(43) Pub. Date: Mar. 3, 2005

(54) Cathode ray tube

(76) Inventor: Seung Tae Ryu, Gumi-si (KR)

Correspondence Address: BIRCH STEWART KOLASCH & BIRCH, PO BOX 747, FALLS CHURCH, VA, 22040-0747, US

(21) Appl. No.: 10/900,268

(22) Filed: Jul. 28, 2004

(30) Foreign Application Priority Data
Aug. 25, 2003 (KR) 58815/2003

(51) Int. Cl. H01J 29/80

(52) U.S. Cl. 313/402

(57) ABSTRACT

A cathode ray tube includes a front side glass panel, a fluorescent screen formed on an inside surface of the panel, a funnel connected to the panel, forming a vacuum tube, an electron gun embedded in the funnel, a deflection yoke for deflecting electron beams emitted from the electron gun in horizontal and vertical directions, and a shadow mask for discriminating the electron beams in colors, in which a diagonal curvature radius (Rd), thickness (t), and effective diagonal length (D) of the shadow mask satisfy a condition of

$$9 , 000 \leq Rd \times \frac{391 mm}{D \times t} \leq 10 , 000.$$

### BACKGROUND OF THE INVENTION

1. Field of the Invention

The present invention relates to a cathode ray, more particularly, to a cathode ray tube including a shadow mask characterized of an improved impact resistance and proper beam arrangement rate.

2. Discussion of the Background Art

FIG. 1 illustrates the structure of a related art cathode ray tube.

Referring to FIG. 1, the related art color cathode ray tube includes a front side glass panel 2, a fluorescent screen 3 coating an inside surface of the panel 2 with red (R), green (G), and blue (B) fluorescent substances, a funnel 5 connected to the panel 2, an electron gun 7 embedded in the funnel 5, emitting electron beams 10, a deflection yoke 6 for deflecting the electron beams 10 in horizontal and vertical directions, and a shadow 4 for discriminating the electron beams in colors.

When a video image signal is input to the electron gun 1 in the cathode ray tube with the above structure, the electron gun 7 emits electron beams 10. The electron beams 10 are deflected in the horizontal and vertical directions by the deflection yoke 6, and pass through electron beam passing holes 41 formed on the shadow mask 4. Then the electron beams 10 strike the fluorescent screen 3, and display a desired image on the screen.

The shadow mask 4 is curved, or has a curvature that is similar to the inside surface curvature of the panel 2, and a plurality of electron beam passing holes 41 are formed thereon.

The electron beam passing holes 41 on the shadow mask 4 are usually made by etching the shadow mask 4. More specifically speaking, one side surface or surfaces on both sides of the shadow mask is (are) elaborately coated with an etching solution, and as a result thereof, the shadow mask 4 is eroded and uniform electron beam passing holes 41 are obtained.

When the shadow mask 4 is too thick it is not easily etched and sizes of the electron beam passing holes 41 are not uniform.

On the other hand, when the shadow mask 4 is too thin, although it can be easily etched, impact resistance of the shadow mask 4 gets weaker. Therefore, the shadow mask 4 can be very easily deformed even by slight impact when it is being transported or in the middle of manufacture.

For the aforementioned reasons, the related art shadow mask 4 was usually thick and thus, sizes of the electron beam passing holes 41 were not uniform, consequently making images on the screen unclear.

Besides, increasing thickness of the shadow mask 4 increased material cost also.

### SUMMARY OF THE INVENTION

An object of the invention is to solve at least the above problems and/or disadvantages and to provide at least the advantages described hereinafter.

Accordingly, one object of the present invention is to solve the foregoing problems by providing a cathode ray tube including a shadow mask in which impact resistance of the shadow mask is improved by optimizing relevant curvature.

Another object of the present invention is to provide a cathode ray tube including a shadow mask in which thickness of the shadow mask is minimized to reduce material cost, and electron beam passing holes formed on the shadow mask are uniform in size.

Another object of the invention is to provide a cathode ray tube including a shadow mask, in which a curvature radius of the shadow mask is adjusted to yield a proper beam arrangement rate.

The foregoing and other objects and advantages are realized by providing a cathode ray tube including: a front side glass panel, a fluorescent screen formed on an inside surface of the panel, a funnel connected to the panel, forming a vacuum tube, an electron gun embedded in the funnel, a deflection yoke for deflecting electron beams emitted from the electron gun in horizontal and vertical directions, and a shadow mask for discriminating the electron beams in colors, in which a diagonal curvature radius (Rd), thickness (t), and effective diagonal length (D) of the shadow mask satisfy a condition of

$$9 , 000 \leq Rd \times \frac{391 mm}{D \times t} \leq 10 , 000.$$

In an exemplary embodiment of the invention, the effective diagonal length of the shadow mask is in a range of 380-500 mm

In an exemplary embodiment of the invention, the thickness of the shadow mask is not greater than 0.1 mm

In an exemplary embodiment of the invention, a ratio of a thickness at a central portion of the panel to a thickness at a diagonal end portion of the panel is not greater than 1.8.

In an exemplary embodiment of the invention, the outside surface of the panel is substantially flat, and the inside surface of the panel has a predetermined curvature.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the structure of a related art cathode ray tube;

FIG. 2 illustrates a shadow mask of a cathode ray tube according to the present invention;

FIG. 3 illustrates a proper beam arrangement in dependence with a curvature radius of a shadow mask according to the present invention;

FIG. 4 illustrates a poor example of beam arrangement because a curvature radius of a shadow mask is less than a predetermined range; and

FIG. 5 illustrates numerical values of impact resistance and beam arrangement rate of a shadow mask for a cathode ray tube according to the present invention.

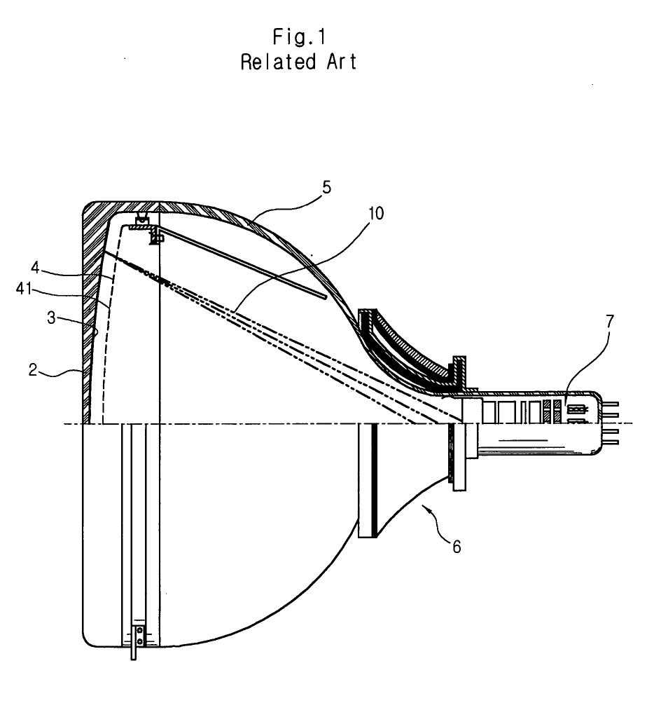

### DETAILED DESCRIPTION OF PREFERRED EMBODIMENTS

The following detailed description will present a cathode ray tube according to a preferred embodiment of the invention in reference to the accompanying drawings.

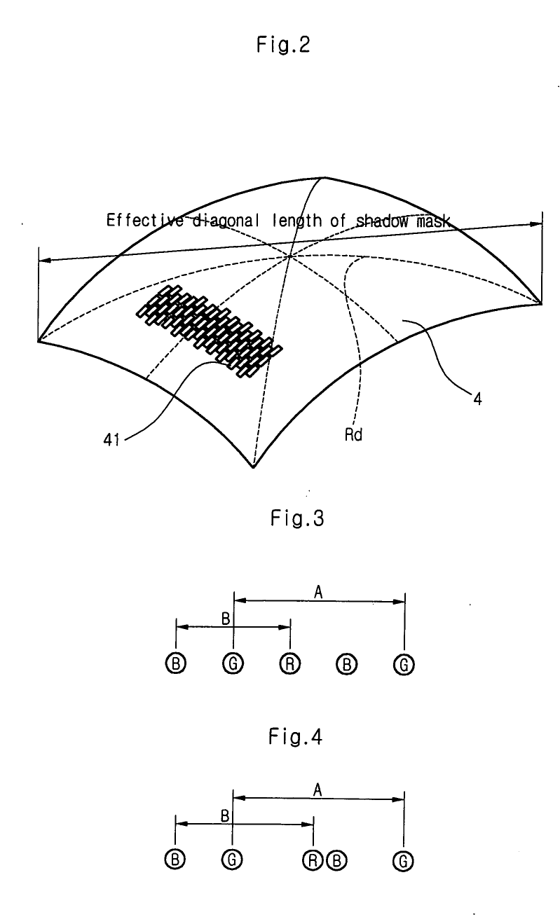

FIG. 2 depicts a shadow mask of the cathode ray tube according to the present invention.

Referring to FIG. 2, the shadow mask 4 is curved or has a curvature similar to the inside surface curvature of a panel of the cathode ray tube. As shown in FIG. 2, a plurality of electron beam passing holes is formed on the shadow mask 4.

The outside surface of the panel is substantially flat, and the inside surface of the panel has a designated curvature. Here, a ratio of the thickness at a central portion of the panel to the thickness at a diagonal end portion of the panel is not greater than 1.8.

Manufacturing the outside surface of the panel to be substantially flat can minimize image distortions on the screen.

If the ratio of the thickness at the central portion of the panel to the thickness at the diagonal end portion of the panel is greater than 1.8, the panel can be damaged during heat treatment process, and uniformity of screen brightness is degraded.

Therefore, the ratio of the thickness at the central portion of the panel to the thickness at the diagonal end portion of the panel should not be greater than 1.8.

Shapes of the electron beam passing holes 41 formed on the shadow mask 4 may vary according as whether the shadow mask 4 is used for a TV or computer monitor. Also, shapes of the electron beam passing holes 41 may vary a little in dependence with manufacturers.

One of key design factors of the shadow mask 4 is a diagonal curvature radius (Rd). As the diagonal curvature radius (Rd) of the shadow mask 4 gets smaller, impact resistance of the shadow mask 4 is linearly increased.

Another thing to be considered is electron beam arrangement formed on a fluorescent screen. For example, when the diagonal curvature radius (Rd) is greater or less than a predetermined range, the path of electron beams having passed through the holes 41 can be changed. This in turn causes a problem to beam arrangement.

Problems in electron beam arrangement are soon manifested by degraded color purity on the screen.

As for beam arrangement, the diagonal curvature radius (Rd) and an effective diagonal length (D) of the shadow mask 4 should be considered together.

FIG. 3 illustrates a proper beam arrangement in dependence with the curvature radius of the shadow mask according to the present invention, and FIG. 4 illustrates a poor example of beam arrangement because the curvature radius of the shadow mask is less than a predetermined range.

Beam arrangement rate can be defined by a following equation.

$$Beam arrangement rate = \frac{B}{A} \times \frac{3}{2} \qquad [ Equation 1 ]$$

Beam arrangement rate shown in FIG. 3 is in a range of 0.97-1.03. On the other hand, beam arrangement rate shown in FIG. 4 is greater than 1.03. As depicted in FIG. 4, because of this great beam arrangement, R beams and B beams are interfered with each other, resulting in deteriorations of color purity of image.

This explains why impact resistance and beam arrangement rate should be considered when determining the diagonal curvature radius (Rd) of the shadow mask.

FIG. 15 graphically illustrates impact resistance and beam arrangement rate in dependence with the diagonal curvature radius (Rd) and thickness (t) of the shadow mask for a 17-inch cathode ray tube of the present invention.

Preferably, the diagonal curvature radius (Rd), thickness (t), and effective diagonal length (D) of the shadow mask of the cathode ray tube should satisfy a following condition.

$$9 , 000 \leq Rd \times \frac{391 mm}{D \times t} \leq 10 , 000 \qquad Condition ( I )$$

In case of the 17-inch cathode ray tube, the effective diagonal length () of the shadow mask 4 comes to 391 mm. Substituting 391 mm for D, the above condition (I) is simplified as follows:

$$9 , 000 \leq \frac{Rd}{t} \leq 10 , 000 \qquad Condition ( II )$$

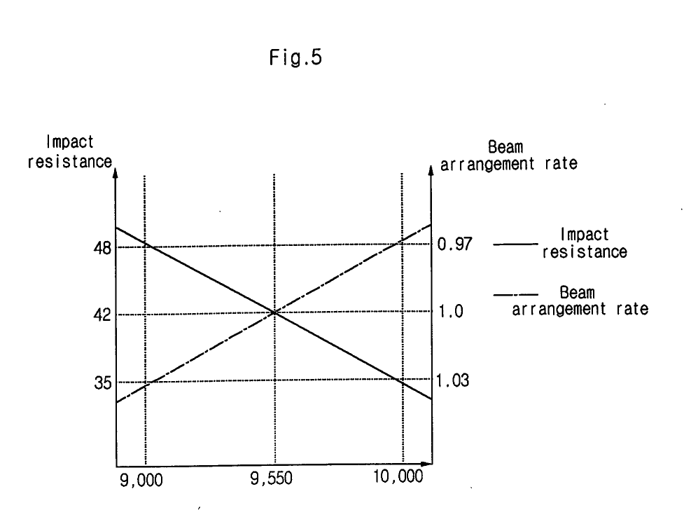

As shown in FIG. 5, when the diagonal curvature radius (Rd), thickness (t), and effective diagonal length (D) of the shadow mask of the cathode ray tube should satisfy the condition of

$$9 , 000 \leq Rd \times \frac{391 mm}{D \times t} \leq 10 , 000 ,$$

beam arrangement rate is in the range of 0.97-1.03, and color purity of image can be protected. Also, impact resistance of the shadow mask becomes greater than 35G, maintaining a sufficient strength against impact.

The condition (II) is obtained when the effective diagonal length (D) of the shadow mask 4 is 391 mm. The cathode ray tube according to the present invention can also be applied even when the effective diagonal length (D) of the shadow mask 4 is between 380 mm and 500 mm.

In other words, when the effective diagonal length (D) of the shadow mask 4 is in the range of 380-500 mm, the shadow mask thickness (t) can be reduced below 0.1 mm, and according to the effective diagonal length (D) and the shadow mask thickness (t), the diagonal curvature radius (Rd) of the shadow mask 4 is changed within a range that satisfies the condition (I). Therefore, it gets easier to maintain the above described color purity and impact resistance.

Particularly, FIG. 5 illustrates a case when the effective diagonal length (D) of the shadow mask 4 is 391 mm, and the thickness (t) of the shadow mask 4 is 0.1 mm. As shown in FIG. 5, when Rd×391 mm/(D×t) equals to 9,550, the impact resistance becomes as strong as 42 G.

Compared with a related art shadow mask, of which effective diagonal length (Rd) is 391 mm and the thickness (t) is 0.12 mm, resulting in 38 G of impact resistance, the shadow mask 4 of the present invention (assuming that the shadow mask 4 satisfied the condition (I)) has an improved impact resistance by more than 10% of the related art impact resistance despite the reduced thickness (t) of the shadow mask 4.

Accordingly, even if the shadow mask 4 may be thinner, its strength can still be improved. Also, a satisfactory beam arrangement rate can be obtained.

In conclusion, by reducing the thickness (t) of the shadow mask 4, manufacturers can reduce material cost.

Moreover, by applying the shadow mask having the proper beam arrangement rate to the cathode ray tube, manufacturers can improve color purity of image.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A cathode ray tube comprising: a front side glass panel, a fluorescent screen formed on an inside surface of the panel, a funnel connected to the panel, forming a vacuum tube, an electron gun embedded in the funnel, a deflection yoke for deflecting electron beams emitted from the electron gun in horizontal and vertical directions, and a shadow mask for discriminating the electron beams in colors, wherein a diagonal curvature radius (Rd), thickness (t), and effective diagonal length (D) of the shadow mask satisfy a following condition of
$$9 , 000 \leq Rd \times \frac{391 mm}{D \times t} \leq 10 , 000.$$

2. The cathode ray tube according to claim 1, wherein the effective diagonal length of the shadow mask is in a range of 380-500 mm.

3. The cathode ray tube according to claim 1, wherein the thickness of the shadow mask is not greater than 0.1 mm.

4. The cathode ray tube according to claim 1, wherein a ratio of a thickness at a central portion of the panel to a thickness at a diagonal end portion of the panel is not greater than 1.8.

5. The cathode ray tube according to claim 1, wherein an outside surface of the panel is substantially flat, and an inside surface of the panel has a predetermined curvature.
